(19) United States
(12) Patent Application Publication
(10) Pub. No.: US 2014/0229358 A1
(43) Pub. Date: Aug. 14, 2014

(54) Low and High Trailing Execution (LHTE) Stop Orders System

(71) Applicant: Michael Edwin Kelley, Simi Valley, CA (US)

(72) Inventor: Michael Edwin Kelley, Simi Valley, CA (US)

(73) Assignee: Michael Edwin Kelley, Simi Valley, CA (US)

(21) Appl. No.: 14/061,396

(22) Filed: Oct. 23, 2013

Related U.S. Application Data
(60) Provisional application No. 61/762,746, filed on Feb. 8, 2013.

(30) Foreign Application Priority Data
Oct. 23, 2013 (US) 14061396

(51) Int. Cl. G06Q 40/04

(52) U.S. Cl. CPC G06Q 40/04
USPC 705/37

(57) ABSTRACT

The Low and High Trailing Execution (LHTE) stop orders system provides a method for a user to specify multiple values to protect stock market investments. This invention allows a user to specify more than one stop loss value including the following: a. the minimum (low) stock or option price via a percentage or number, b. the maximum (high) stock or option price via a percentage or number and c. the trailing stop price via a percentage or number. These user-specified values are kept internally in the stop orders system and at the appropriate time converted to a market order. These are not market orders nor are they one-cancels-all orders, one-cancels-other orders or if-then strategies which are all types of market orders.

### TECHNICAL FIELD

The present invention relates generally to an automated method involving multiple user specified values and details a process for selling/buying investments based on those user specified conditions. The present invention relates more specifically to an improved stock or option order system incorporating these boundaries set by the user.

### BACKGROUND

A stock or option trading order is inherently risky. A buy order is submitted via a brokerage to the stock exchange or market to buy a stock or option at your price target. Normally that order is fulfilled immediately. Then you submit a second order via a brokerage to the market to sell your stock or option at a higher price target. If the stock or option price rises above your price target and your order is fulfilled, you make a profit. But if the stock or option price goes down suddenly and you find out belatedly, you could lose a lot of money by the time you change your target selling price. This requires a lot of monitoring by the user.

Some brokerages help the user in this selling situation by offering trailing stop orders. These selling orders are kept internal to the brokerage and follow or “trail” the stock or option price. If the stock or option price falls the percentage or amount specified by the user or if the stock or option price rises for a while and then falls the same percentage or amount specified by the user. a sell order is sent to the market. This sell order is usually executed immediately. This type of order reduces monitoring and minimizes losses but is geared toward expecting a loss. This trailing stop order is also limiting because only one percentage or price is allowed to be specified.

Quoting a well known stock trader and advisor, Daryl Guppy, in http://www.justdata.com.au/Journals/DarylGuppy/holiday_trade.htm “Any stop loss technique is better than no stop loss technique, but the arbitrary nature of the floating % stop loss soon leads to dissatisfaction. It takes traders out of trades too early as the trend continues, or too late as the trend has already turned.”

On the other hand, a Low and High Trailing Execution of stop orders system or LHTE stop orders system is different from a system using trailing stop orders because it is geared toward maximizing profit with a lot less monitoring. As soon as a user buys, a stock or option, the anticipated low and high selling price both can be identified by the user along with a trailing stop value via an LHTE stop orders system as seen in FIG. 1.

Then the LHTE stop orders system maintains an internal trailing stop order as seen in FIG. 4 If the stock or option price falls and passes the low price target specified by the user, an immediate sell market order would be placed as seen in FIG. 2.

If the stock or option price instead rises and passes the high price target then the LHTE stop orders system starts monitoring the high stock or option price and any falls in price. If the stock or option price falls the trailing stop percentage or amount specified by the user, an immediate sell market order would be placed as seen in FIG. 3.

Also the present invention, unlike other patents, supports shorts. As soon as a user shorts a stock, the anticipated low and high buying price both can be identified by the user along with a trailing stop value via an LHTE stop orders system as seen in FIG. 1. Then the LHTE stop orders system would maintain an internal trailing stop order as seen in FIG. 5. If the stock price rises and passes the high price target specified by the user, an immediate buy market order would be placed. If the stock price falls and passes the low price target then the LHTE stop orders system starts monitoring the low stock price and any rises in price. If the stock price rises the percentage or amount specified by the user, an immediate buy market order would be placed.

In addition, a LHTE stop orders system is “light” on risk. If you take your eye off the market which is often the case for users that are not day traders, there is a risk of losing money. The advantage of the LHTE stop orders system is instead of having one selling price or percent and constant monitoring of the stock market, you have multiple selling values and no monitoring. You can enter a low price or percent, a high price or percent and a trailing percent. For example, you could enter 3%, 5% and 2% as seen in FIG. 1. So if the price goes down 3%, you limit your losses as seen in FIG. 2. If the stock or option price goes up 5%, the trailing stop kicks in and as soon as the price drops 2%, it is sold as seen in FIG. 3. This maximizes your gain.

### BRIEF DESCRIPTION OF THE DRAWINGS

The inventive subject matter will be described in conjunction with the following drawing figures, wherein like numerals denote like elements, and

FIG. 1 is a simplified diagram of the parameters available to a user submitting an LHTE stop order to a brokerage;

FIG. 2 is a simplified diagram of a brokerage submitting the sell market order using the low price;

FIG. 3 is a simplified diagram of a brokerage submitting the sell market order using the falling price difference or percentage from the last known sale price;

FIG. 4 is a simplified diagram of the LHTE logic a brokerage could use to determine when to submit the sell market order;

FIG. 5 is a simplified diagram of the LHTE logic a brokerage could use to determine when to submit the buy market order;

The following detailed description of the inventive subject matter is merely exemplary in nature and is not intended to limit the inventive subject matter or the application and uses of the inventive subject matter. Furthermore, there is no intention to be bound by any theory presented in the following detailed description.

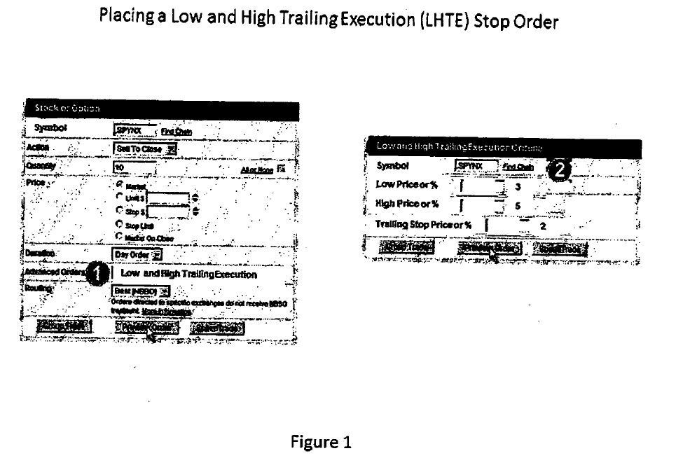

University of Southern California Professor of Finance, Lawrence Harris, found that the Average Spread (Percentage of Price) at the Toronto Stock Exchange in November 1994 was 2.88 percent as presented in Table 1 on page 28.* So in FIG. 1 we assume that most stocks will not change more than 3 percent in a day on average. Professor Harris also found the maximum Average Spread was 11.79 percent. So this means the stock price should not change by more than 11.79 percent.

Thus in FIG. 1, “Placing a Low and High Trailing Execution (LHTE) Stop Order”, we enter possible LHTE stop order values assuming a downside limit of 3 percent and an upside limit of 5 percent. We also enter a value of 2 for the trailing stop value to limit the subsequent downside fall after gaining 5 or more percent.

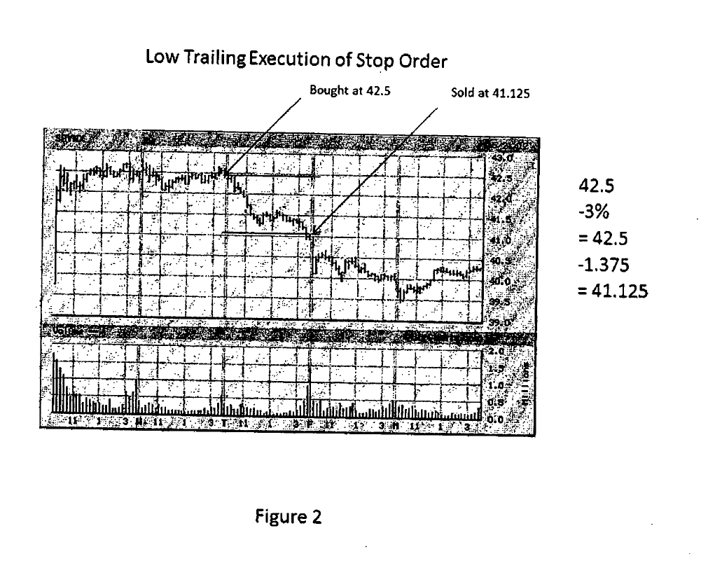

In FIG. 2, “Low Trailing Execution of Stop Order”, a stock we bought at $42.5 per share, has a 3 percent lower selling limit which is $42.5 times 0.03 or $1.375. Taking $42.5 minus $1.375, we arrive at the low selling price of $41.125.

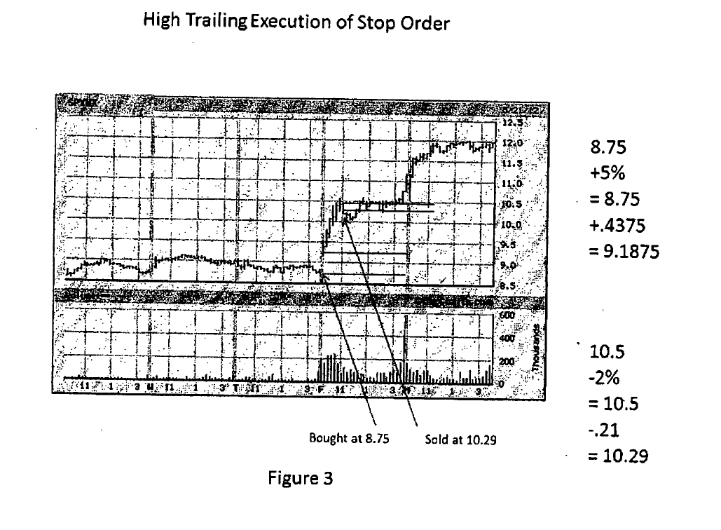

Likewise, in FIG. 3, “High Trailing Execution of Stop Order”, a stock we bought at $8.75 per share, the 5 percent upper limit would be $8.75 times 0.05 or $0.4375. Taking $8.75 plus $0.4375, we arrive at the high selling price of $9.1875. But instead of selling at $9.1875, we would activate a trailing stop of 2 percent. So once we reach our 5 percent upper limit, we would continue to rise and limit our loss to 2 percent less of the maximum which in this case is $10.5. Specifically, we have a trailing stop of $10.5 times 1 minus 0.02 or $10.5 times 0.98 or $10.29. Thus in FIG. 3, we went from $8.75 to $10.29 for a gain of 17.6 percent.

Embodiments include methods and processes for handling trailing stop orders but specifically designed around the multiple values supplied by the user. While various exemplary embodiments have been presented in the foregoing detailed description, it should be appreciated that a vast number of variations exist. It should also be appreciated that the exemplary embodiments are only examples, and are not intended to limit the scope, applicability or configuration of the inventive subject matter in any way. Rather, the foregoing detailed description will provide those skilled in the art with a convenient road map for implementing various embodiments of the inventive subject matter, it being understood that various changes may be made in the function and arrangement of elements described in an exemplary embodiment without departing from the scope of the inventive subject matter as set forth in the appended claims and their legal equivalents.

The inventor claims the invention declared herein as follows:

1. A method for allowing users to specify multiple percentages or values including the low and high ends of a stock or option price range and a trailing stop value in order to limit losses and maximize profits without a lot of user monitoring. See FIG. 1.

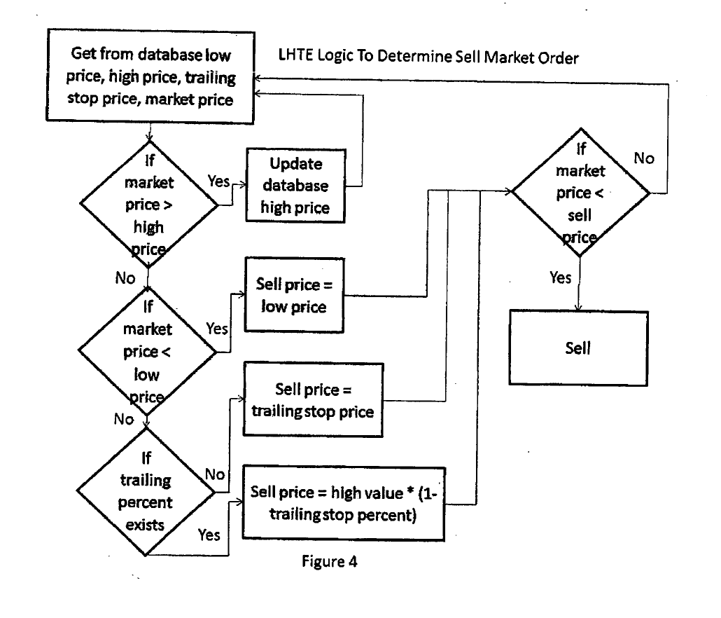

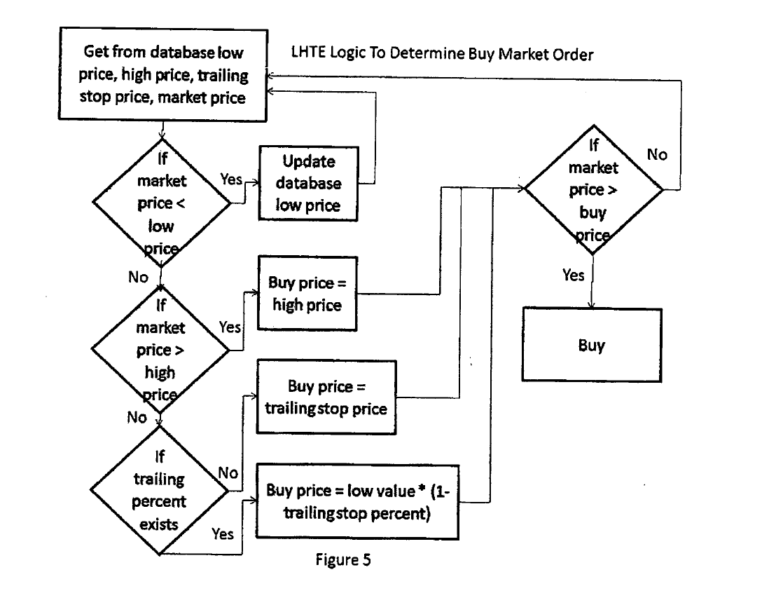

2. The method of claim 1, wherein brokerages establish systems to perform the following: a. convert user percentages to stock or option prices, b. maintain an internal trailing stop order, c. monitor stock or option prices and d. sell/buy the user's stock or option when the low or high end prices are reached. See FIGS. 2, 3, 4 and 5.
